(19) United States
(12) Patent Application Publication
(10) Pub. No.: US 2007/0271301 A1
(43) Pub. Date: Nov. 22, 2007

(54) Method and system for presenting virtual world environment

(75) Inventor: Alx Klive, London (GB)

Correspondence Address: DOCKETING SPECIALIST;SULLIVAN & WORCESTER LLP, ONE POST OFFICE SQUARE, BOSTON, MA, 02109, US

(73) Assignee: Affinity Media UK Limited, London (GB)

(21) Appl. No.: 11/799,589

(22) Filed: May 2, 2007

Related U.S. Application Data
(60) Provisional application No. 60/746,284, filed on May 3, 2006.

(51) Int. Cl. G06F 17/00

(52) U.S. Cl. 707/104.1

(57) ABSTRACT

A method and system are provided for presenting a virtual world environment to users operating client devices connected to a network. The method includes (a) receiving data from one or more automated data miners or a plurality of contributors describing places on a planet at specified time periods; (b) storing the data received in step (a) in one or more databases; (c) receiving one or more requests from one of the users for data describing a place on the planet at one or more time periods; and (d) generating multimedia representations of the place at different time periods based on data in the one or more databases, and transmitting the multimedia representations to the user to be presented to the user on a client device operated by the user, at least one of the multimedia representations including a user interface element selectable by the user to change the multimedia representation of a place at one time period to a multimedia representation of the place at a different time period.

### CROSS REFERENCE TO RELATED APPLICATION

This application claims priority from U.S. Provisional Patent Application No. 60/746,284 filed on May 3, 2006, entitled Virtual Reality Time Machine And World Simulator, which is hereby incorporated by reference.

### BACKGROUND

1. Field of the Invention

The present invention relates generally to methods and systems for presenting multimedia content to users of client devices connected to a network. More particularly, the invention relates to methods and systems for presenting a virtual world environment to online users, allowing users to explore and interact with other users at different places at different moments in time.

2. Related Art

The Internet and other communications networks have become popular media for commerce, entertainment, communication, and information. Virtual reality worlds such as secondlife.com and there.com provide generally realistic 3D virtual reality environments, in which users can explore, interact, and communicate with other users, with individuals being represented in the form of “avatars.” An “avatar” refers to the physical incarnation of an online user in the virtual reality world. Massively multiplayer online games (MMOG's) such as World of Warcraft and Everquest are popular computer games that enable hundreds or thousands of players to simultaneously interact in a virtual game world they are connected to via the Internet.

### BRIEF SUMMARY OF EMBODIMENTS OF THE INVENTION

In accordance with one or more embodiments of the invention, a method is provided for presenting a virtual world environment to users operating client devices connected to a network. The method includes (a) receiving data from one or more automated data miners or a plurality of contributors describing places on a planet at specified time periods; (b) storing the data received in step (a) in one or more databases; (c) receiving one or more requests from one of the users for data describing a place on the planet at one or more time periods; and (d) generating multimedia representations of the place at different time periods based on data in the one or more databases, and transmitting the multimedia representations to the user to be presented to the user on a client device operated by the user. At least one of the multimedia representations includes a user interface element selectable by the user to change the multimedia representation of a place at one time period to a multimedia representation of the place at a different time period.

In accordance with one or more embodiments of the invention, a system is provided for presenting a virtual world environment to users operating client devices connected to a network. The system includes a computer system for receiving data from one or more automated data miners or a plurality of contributors describing places on a planet at specified time periods; and one or more databases for storing the data. The computer system receives one or more requests from one of the users for data describing a place on the planet at one or more time periods, generates multimedia representations of the place at different time periods based on data in the one or more databases, and transmits the multimedia representations to the user to be presented to the user on a client device operated by the user. At least one of the multimedia representations includes a user interface element selectable by the user to change the multimedia representation of a place at one time period to a multimedia representation of the place at a different time period.

In accordance with one or more embodiments of the invention, a method is provided of experiencing a virtual world environment by a user operating client device connected to a computer system. The computer system stores data received from one or more automated data miners or a plurality of contributors describing places on a planet at specified time periods. The method includes the steps of transmitting one or more requests to the computer system for data describing a place on the planet at one or more time periods; and receiving multimedia representations of the place at different time periods generated by the computer system based on data in the one or more databases. The multimedia representations are presented to the user on the client device operated by the user. At least one of the multimedia representations includes a user interface element selectable by the user to change the multimedia representation of a place at one time period to a multimedia representation of the place at a different time period.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a simplified block diagram illustrating a system for presenting a multimedia virtual world environment to an online user in accordance with one or more embodiments of the invention.

FIG. 2 is a flowchart illustrating a method of presenting a multimedia virtual world environment to an online user in accordance with one or more embodiments of the invention.

FIGS. 3A to 3D are exemplary screen shots illustrating a virtual world environment presented to a system user on a client device operated by the user.

FIG. 4 is an isometric view of a conceptual database for storing virtual world representations of a planet in accordance with one or more embodiments of the invention.

FIG. 5 is an isometric view of a conceptual database illustrating a history storage feature in accordance with one or more embodiments of the invention.

### DETAILED DESCRIPTION

### High-Level Overview

The present invention is directed to methods and systems for presenting a virtual world environment to online users, allowing the users to explore and/or interact with other users at different places at different moments in time. As will be described in further detail below, the system can include one or more host computers or servers, which a plurality of users can access via a communications link using a variety of possible client devices. Software on the client devices allows users to interact with software running on the host computers or servers. The users can experience a 3D virtual world within which they can explore and interact with other users and non-playing characters. Users and characters can be represented in the form of avatars. A virtual time machine is thereby provided that allows users to travel to generally any place and moment in time, and experience and interact with historical events and characters, as if they were there physically.

The methods and systems described herein can provide generally realistic re-creations to users for various purposes including, but not limited to, entertainment, commerce, communication, government work, research, education, and information.

The virtual world system in accordance with one or more embodiments of the invention includes a platform that allows users to improve the experience for both themselves and other users by augmenting the information used to generate the virtual world environment, and storing information, or references to information that can be used to create improved automatic simulations.

Additionally, methods and systems in accordance with various embodiments of the invention can allow scientists and researchers to access instances of the world that they can use for highly complex simulations of the real world. These simulations can include, e.g., social behavior, the use of resources, weather, climate change, pollution, traffic, space physics, the effect of government policy, and other aspects of our world that would benefit from a simulation of a planet.

### Description of Embodiments

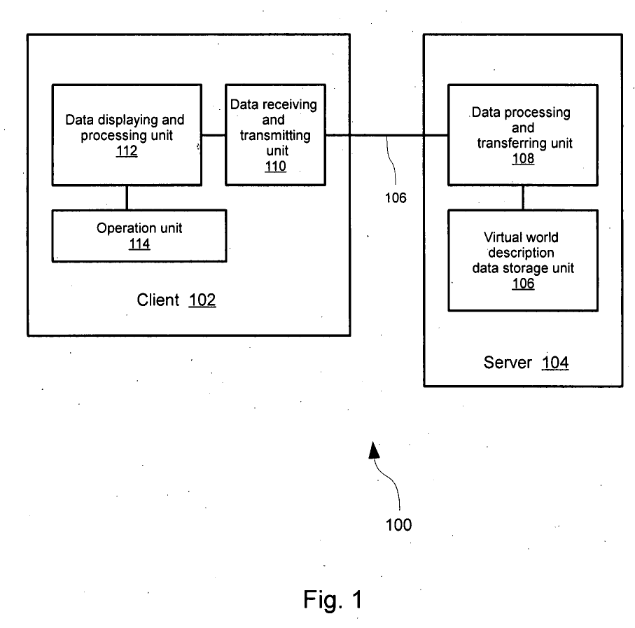

FIG. 1 illustrates a system 100 for presenting a multimedia virtual world environment to system users in accordance with one or more embodiments of the invention. The system 100 employs a client/server architecture and includes a plurality of client devices operated by users such as client device 102 connected via a communication channel 106 to one or more host computers or servers such as server 104.

The server 104 includes a data storage unit 106 containing data describing the virtual world. The data storage unit 106 connects through a data processing and transfer unit 108, to a data receiving unit 110 and data displaying and processing unit 112 on the client device 102.

The server 104 generates a virtual world environment, which can be, e.g., a 3D visual and audio experience, based on information stored within the data storage unit 106. The virtual world environment is relayed to the client device 102, and then presented to the user, e.g., shown by way of a display to the user and heard through an audio speaker device.

The user operates a user input device 114 such as, e.g., a keyboard or mouse to send commands to the server 104 such as, e.g., select date, select place, move forward, move left, pick up an object, etc. The server 104 responds by updating the visual and/or audio experience according to those commands, and according to any other events occurring within the same approximate 3D space at that time, which it tracks.

Multiple users can exist, e.g., as avatars, in the same 3D space at the same time as multiple clients 102 to the same server 104. The users can accordingly virtually see and interact with one another.

The client device 102 may be a personal computer such as, e.g., a Pentium®-based desktop or notebook computer running an operating system such as, e.g., a Windows® operating system. The client device 102 can include a browser, also referred to as a web client, which may, e.g., be any of a variety of conventional web browsers such as the Microsoft Internet Explorer® or Mozilla Firefox® web browsers. Alternatively, the client device 102 may be a portable communication device such as, e.g., a personal digital assistant (PDA) or a cellular telephone. Another possible client device 102 is a 3D virtual reality headset system as will be described in further detail below.

The channel 106 can be, e.g., the Internet, an intranet, or other computer or communications network connection. In the case of the Internet, the server 104 is one of a plurality of servers that are accessible by a plurality of clients such as the client device 102. The client device 102 can be connected to the server 104 by, e.g., the User Datagram Protocol (UDP), which is a connectionless protocol, or by the Transmission Control Protocol (TCP), or other suitable protocol, to provide users access to files, which can be in different formats such as text, graphics, images, sound, video, etc.

Data describing the virtual world ordinarily ‘starts out’ in the data storage unit 106, and is relayed, usually ‘on demand’, to the client computer 102. In accordance with one or more embodiments of the invention, this description data can also be ‘cached’ locally at the client computer 102, and this has the effect of reducing subsequent data transfer from the server. In accordance with one or more embodiments of the invention, the description data can also be distributed as part of the client software that runs on the client computer 102, or as periodic software updates to the client software running on the client computers. (Anti-virus software programs are an example of programs where the description data (for virus signatures) are periodically downloaded to the client software from a host computer.) Accordingly, while the description herein often refers to databases being part of the server 104, and more specifically the storage unit 106, it should be understood that it is also possible to have these exist as databases on the client computers 102.

Moreover, in accordance with one or more embodiments of the invention, the system can be implemented in a peer-to-peer (P2P) computer network where there is no central server. Instead, the data describing the virtual world can be distributed geographically across a plurality of client devices around the world. Using peer-to-peer techniques, copies of the data could, e.g., be stored in approximate geographically accurate positions (if replicating the Earth).

For instance, data describing locations in England could be stored in storage devices located in England, since contributors and users of the data would more likely be from England. This would have the benefit of ease of understanding for users and contributors, and would offer benefits for efficiently routing data and reducing latency. It would also have the benefit of lowering costs for central hardware as there would be no central server.

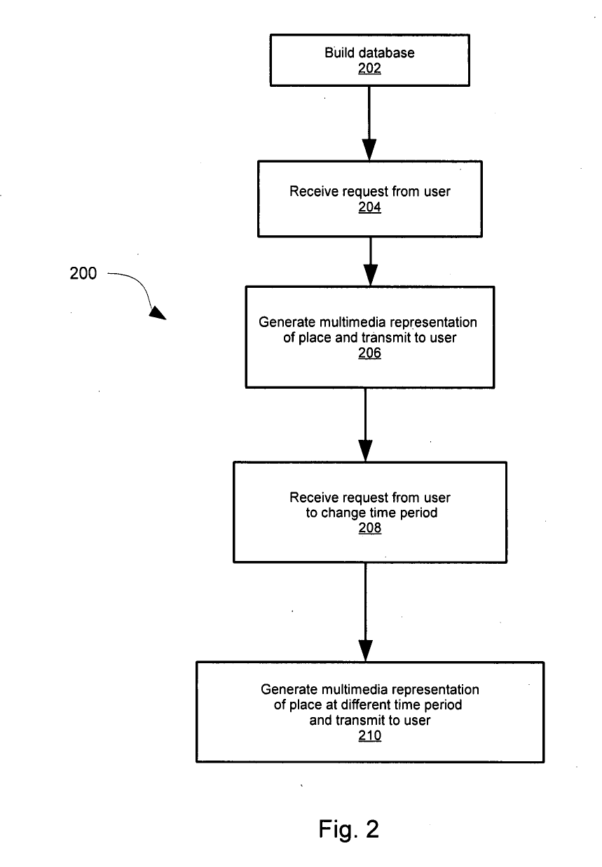

FIG. 2 shows a flowchart 200 illustrating an exemplary process of presenting a virtual world environment to an online user in accordance with one or more embodiments of the invention. At step 202, one or more databases are built containing data describing a virtual world environment at different time periods. The database and process of building it are described in further detail below.

At step 204, a request is received at the server 104 from a system user operating a client device 102 for data describing a place on a planet at a specified time period.

At step 206, the server generates a multimedia representation of the place at the specified time period based on data in the data storage unit, and transmits it to the client device 102. The multimedia representation of the place at the specified time period is processed by the client device 102 and presented to the user, e.g., as an audio/visual experience.

At step 208, the server receives a request from the user for data describing the place at a different time period. At step 210, the server generates a multimedia representation of the place at the different time period, and transmits it to the user.

In one or more alternative embodiments, data describing places at different time periods is cached on the client device 102. In this case, the user is presented a multimedia representation of a place at a requested time period. If the user wishes to view the place at a different time period, the multimedia data for the different time period can be retrieved from data cached on the client device. Accordingly, a further request to the server 104 need not be made for that data.

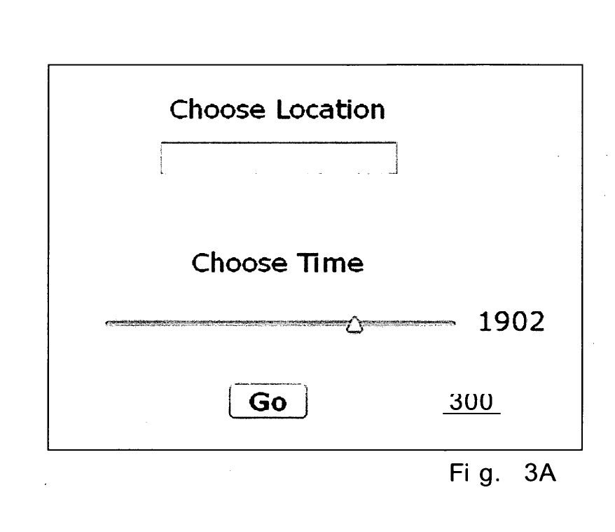

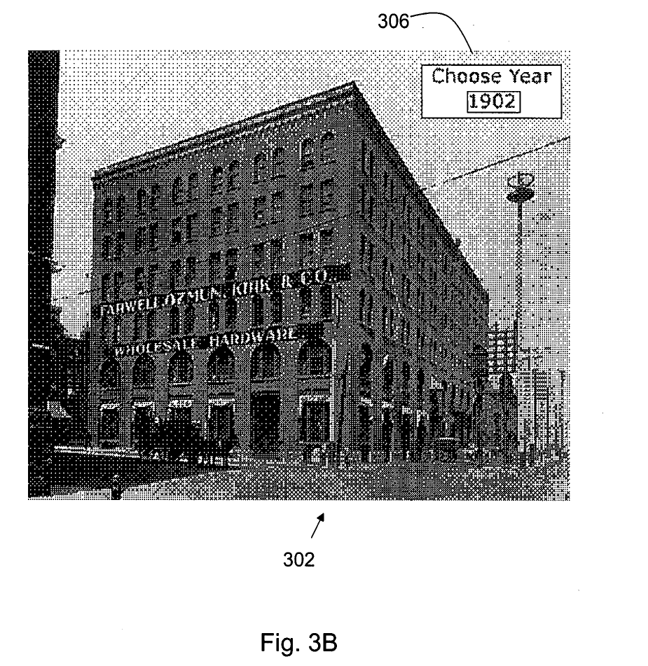

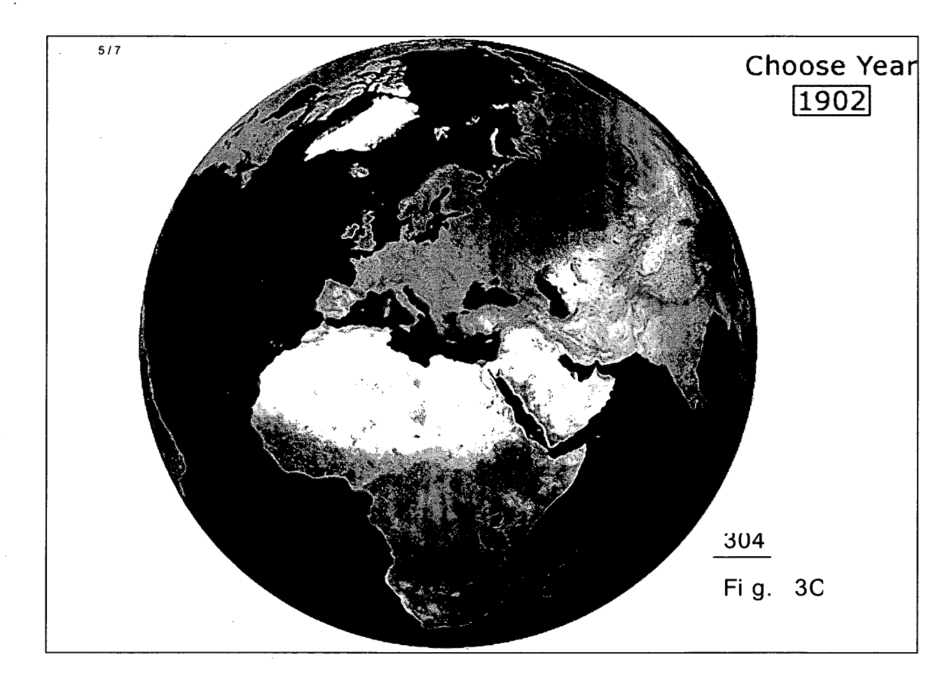

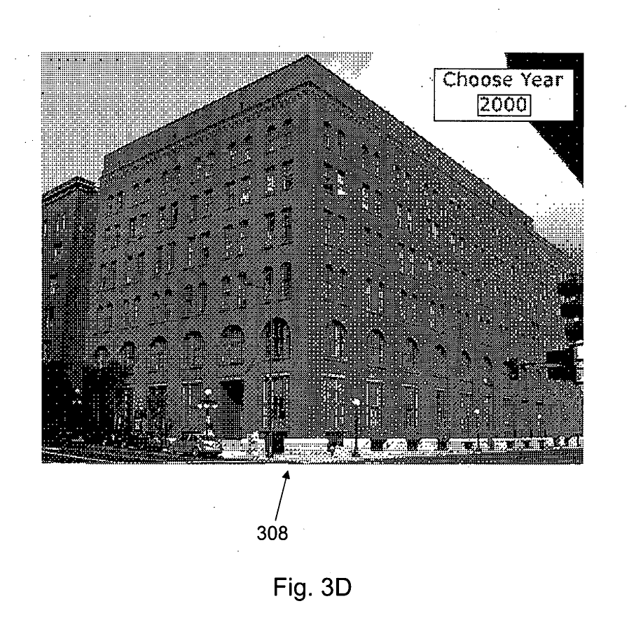

FIGS. 3A-3D illustrate exemplary screenshots of multimedia representations presented to the user on the client device 104. FIG. 3A illustrates a screen image 300 on the client display, at which the user can select a location and time that he or she wishes to travel to. For example, the user can enter a location such as “St. Paul, Minn.” at a time period such as “1902”. This data is sent to the server 104, which generates a reproduction of that location and time using information stored within its data storage unit, and passes the data to the client device 102 for reproduction to the user, e.g., in the form of screenshot 302 shown in FIG. 3B.

Alternatively, as shown in the screenshot 304 of FIG. 3C, the user can choose a time such as the year 1902, and select a location by ‘flying over’ a 3D representation of the planet surface. The user can descend (or zoom in) to a location, and once below a certain height, descend ‘through the clouds’ to the planet surface to the desired location, e.g., as shown in the screenshot of FIG. 3B. In this embodiment, the system can switch between two different computing systems, one for scrolling and zooming into or out of a 3D globe, and the other the main 1st person perspective 3D engine. Examples of such a 3D globe are Google Earth and NASA World Wind. The switch between the two engines can be seamless, animated, or presented as a movie.

Once presented with a virtual world representation of the selected location and time (e.g., screenshot of FIG. 3B), the user can virtually travel in time to a different time period at the same location by selecting a different time period. In the FIG. 3B screenshot, the user can change the time period through user interface element 306, which allows a new time period to be entered.

Once a different time period has been selected, a further request is sent to the server 104, which generates a reproduction of the location at the different time period. That data is sent to the client device to be displayed, e.g., as a screenshot 308 of FIG. 3D, which shows the same location at the selected year 2000.

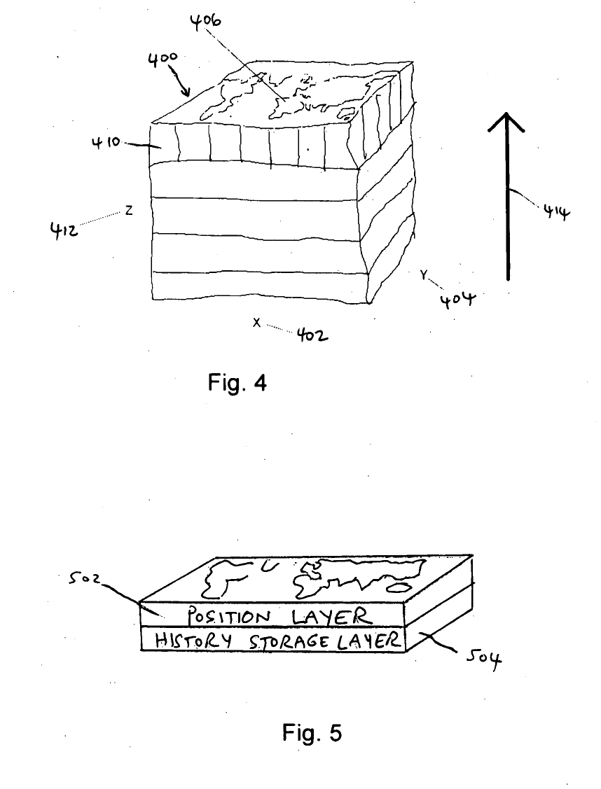

In accordance with various embodiments of the invention, the data describing a virtual world is stored in one or more databases, usually in a series of databases, e.g., in the storage unit 106 of the server computer 104. For purposes of illustration, from a conceptual standpoint, the main database for storing a virtual replica of a planet at a plurality of periods or moments in time can be thought of as a cube such as cube 400 shown in FIG. 4. The x-axis 402 and y-axis 404 of the cube 400 represent positional information for objects upon a map of the planet 406. Horizontal slices 410 of the database represent the position of objects within the world at a specific instance in time. The t-axis 412 of the database represents time, with time moving in the direction as per the arrow 414.

Although a database does not actually have a physical shape per se, this conceptual cube concept is provided for purposes of illustration and explanation. In reality, the database would likely be implemented as multiple standard databases or files, but using the same idea of storing information by location and time. Methods of building such a database system are known to those skilled in the art of databases. Such a cube can store both positional and time information—the ‘where’ and ‘when’ of an object, within the virtual world. (An object might be a building or a lamppost or a tree or a car etc.) By specifying a location X, Y, and a time T, one can specify the location and time of any object anywhere in the virtual world in relation to the planet surface. By moving up and down the cube through time, those same objects might move location, appear, disappear etc, within the database. In other words, the cube can be used to record the location of every object on the virtual planet, at many moments in time, in such a way that the location of those objects can be ‘played back’ on demand, based on a user-specified input of the time T a user is interested in, and the location X, Y.

Since objects can also have a height relative to the planet surface, the height of the object Z within the cube is stored (although this is not explicitly shown in the FIG. 4). In accordance with one or more embodiments of the invention, each slice of the cube 400, representing an instance in time, could be considered to have some ‘height to it’, allowing a small z-axis within that slice, and thus allowing objects within the slice to be positioned above or below the planet surface (or other suitable reference point).

With sufficient granularity, and storage space, it is possible to store within the cube an exact replication of the planet, and all its objects, at microsecond intervals. (Parallels can be drawn here to the sampling of audio and video signals. The cube would essentially sample the location of objects of an entire virtual planet, many times per second. The system can thus be considered, in part, a ‘sampling of 3D space’ or a ‘sampling of life itself’). Such a system may however be inefficient since many objects on a planet (e.g., a building or a tree) do not move much or very often. In this system, there would accordingly be a lot of repetitive information. This is analogous to how raw digital audio files (e.g., AIFF format) tend to be quite large, compared to their more efficient and compressed cousins, the MP3 format. In practice, the data would be compressed prior to storage using any number of different known methods. The basic premise remains however, objects have details of their location (X, Y, Z) recorded over time T, in such a way that they can be reproduced or ‘played back’ later on.

In many cases, simply recording an X, Y, and Z co-ordinate for an object is not actually sufficient for orienting an object. A chair, e.g., can be turned to face different directions, but still have the same X, Y, and Z co-ordinate. The chair could even be turned upside down and retain the same X, Y, and Z co-ordinates.

In accordance with one or more embodiments of the invention, positioning and orientation information is stored within the cube in the form of three or more co-ordinates or ‘anchor’ points. Other methods could also be used. An anchor point is a single set of X, Y, and Z co-ordinates, and three anchor points (nine coordinates in total) is sufficient to position and orient most objects within a 3D space. Flexible, as in non-rigid objects, may require more than three anchor points to orient them correctly, as discussed in further detail below. Other methods of storing the orientation of an object are also possible, and those skilled, e.g., in the art of computer games, would recognize how to build them.

In accordance with one or more embodiments of the invention, the terrain, or more specifically the topography, of the planet is stored within the system prior to recording the position and orientation of objects. There are different ways of recording topography in a computer, and those experienced in the art, e.g., of games and virtual worlds will be familiar with the various methods. One simple method is to store a series of elevation readings, representing the height of the surface of the Earth in relation to sea level, and recording these at multiple points across a map of the Earth. Space Shuttle mission STS-99 for instance recorded the height of the Earth every 30 meters on the ground, for approximately 80% of the Earth's surface. Such data can readily be used by standard 3D software to reproduce a 3D model of the Earth's surface topography.

By combining positional and orientation information with topography data, a computer can re-create the appearance of locations on Earth along with its objects (trees, buildings, people, etc). Data on the position and orientation of the objects relative to the topography for different time periods can be provided by contributors in a collaborative effort to create virtual representations of locations on the planet at different time periods. Data can also be provided by automated data mining tools like web spiders (used by search engines like Google) that can fetch relevant data from websites. In addition, interpolation techniques can be used to fill in missing data.

The topography data could be stored within the cube, or in a separate database that is referenced by the cube. It could also be stored on the client computer 102. Note that topography would change over time (plate tectonic shifts, land reclamation, etc.), and therefore in accordance with one or more embodiments of the invention, new topography data is stored within the data storage unit 104, and optionally the client computer 102, whenever there is a significant change in topography. An automated update mechanism could be used for this purpose.

In accordance with one or more embodiments of the invention, another database (as part, e.g., of storage unit 106), can be used to hold details of each object. This can be in the form of 3D models, comprising wireframes, surface colors, and surface detail, among other details describing an object, such as the materials it is made out of. Objects can be grouped together to make other bigger objects. Objects can have varying sizes. For example, objects can be as small as molecules and atoms or as large as buildings.

In accordance with one or more embodiments of the invention, another database, e.g., as part of storage unit 106, can store information regarding materials including, e.g., their properties and how they behave in different conditions. A material might be concrete, wood, silk, rubber, etc.

In accordance with one or more embodiments of the invention, another database can store laws of science and nature such as laws of physics, astronomy, biology, and chemistry.

In accordance with one or more embodiments of the invention, another database can store information about behavior. Behavior can be relevant for living objects such as people, animals, and plants. Objects are linked to information about their behavior. Behavior might include, e.g., animations of things like walking or clapping, it might include patterns of behavior such as stopping at a pedestrian crossing and pressing a button before crossing.

Data from these databases can be used to re-create a generally realistic virtual world environment, using simulations of the same forces and behaviors existing in the real world.

In accordance with one or more embodiments of the invention, a system is provided to store historical data, e.g., the history of the world by classifying or associating it through time and location. Generally any piece of history can be classified by where it happened and when it happened. As previously discussed, the cube can hold information tied to locations and times. The cube can thereby provide a storage mechanism for historical data. In accordance with one or more embodiments of the invention, a ‘space’ or repository is provided to deposit data such as computer files or references to historical information, within the cube at the places corresponding to the ‘where’ and ‘when’ of that historical information. This space or repository for historical information can be conceptualized as a second ‘layer’ underneath the slice of the cube that holds the positional and orientation information. FIG. 5 shows an isometric view of the history storage system, as it might be embodied in the theoretical database system shown in FIG. 4. The system comprises a position layer 502 and a history storage layer 504, that together represent a single slice 410 of the cube 400.

Another way to conceptualize this history storage layer is that it is akin to a ‘basement’, where files can be stored. Where the historical information is ‘fuzzy’, or unsure, a fuzziness or reliability-of-information indicator can be recorded along with it. For example, it might not be known exactly where a historical event happened, or it might not be known exactly when a historical event happened.

In accordance with one or more embodiments of the invention, users and contributors such as historians can take ‘ownership’ of the ‘basement’ areas within the cube, where they have a personal interest or expertise. For example, one or more historians can be responsible for ‘France during World War 2’, and another one or more historians can be responsible for ‘Washington in the 1950s’. The contributors can work to find articles and information of historical importance, with the goal of building a comprehensive history of the world. (The website Wikipedia is an example of people contributing their knowledge on specific subjects with a community goal of building an encyclopedia.) Such articles (or references to them, e.g., on Wikipedia) would then be placed by the contributor into the correct locations within the cube. These can include, e.g., photos, movies, the text of books, or URL's linking to relevant information or media on other websites. A contributor might decide to concentrate on the present and, e.g., take photographs of his or her entire street, while collecting stories from local residents about interesting things or characters. These can then be deposited into the system.

In accordance with one or more embodiments of the invention, an automated process is used to augment this manual process, whereby a web spider fetches historical information from websites all over the Internet, and use context or other information to determine the location and time to which the information relates, and stores it in the cube.

Subsequently, artificial intelligence or other software, integrated into the virtual world system, can use the stored historical information, or referenced historical information, to generate engaging and generally realistic virtual re-creations of historical events. In accordance with one or more embodiments of the invention, the information itself would not necessarily need to be organized, other than by time and location.

In accordance with one or more embodiments of the invention, re-creations of historical events can be reproduced in a manual or semi-manual fashion, whereby characters, locations and scripts are programmed into the system, much like a director and writer would create a film or a play. Users and creators can take a specific location and time, and build a re-creation of a historical event that took place there, which other users could later experience.

Therefore, in accordance with one or more embodiments of the invention, a user can select a location and time to travel to, and the system would access that part of the cube, both the position layer and history storage layer, along with the other databases, and utilize software to generally realistically re-create the scene requested based on the available information. Accordingly, upon selection of a time and location to travel to, a user could travel virtually to generally any place and moment in time.

In accordance with one or more embodiments of the invention, techniques are provided for reducing data transfer requirements of the virtual world system. A common problem with virtual worlds is efficiently transferring information between server and client. Since the telecommunications link between server and client is typically the Internet, limitations on bandwidth, as well as problems with latency, combine to detract from an engaging user experience. It is often not possible to pass the information fast enough in real-time with existing methods, for a realistic user experience. Common problems include delays as objects appear and delays as users reposition. It is clearly undesirable to have such delays in an effort to re-create real world environments in a realistic manner. Providing a high degree of realism and over a large geographical area places an even higher demand for efficient data transfer.

In accordance with one or more embodiments of the invention, techniques are provided for prioritization of objects. To render a typical scene (e.g., a living room), in a virtual world, existing systems typically use one of two methods. They either transfer the 3D object details for objects that are a) a set distance from the user's avatar (proximity method), or b) all objects within the field of view (field of view method). Both methods are generally inefficient. If you are a user within the virtual world, just as in the real world, you are either ‘inside’ or ‘outside’. (Any borderline areas such as courtyards and terraces are considered ‘outside’). In accordance with one or more embodiments of the invention, a ‘room’ system is provided for object prioritization. When a user is ‘outside’, there is typically no need to see the interior contents of a building, and thus from a system perspective, there is no need to immediately transfer the data for the objects that are inside a building, even if the user is very close to that building. The proximity methods used in some known virtual world systems would in comparison send (or pass) those objects over the communications link, and this is clearly inefficient.

When someone is ‘inside’, there is typically no need to see objects that are outside the building, or in other rooms within the same building, and thus from a system perspective, there is no need to immediately transfer the data for those objects. Again, the proximity method above would in comparison send those objects, which is inefficient.

If you are in a room, and using the field of view method outlined above, there can be delays if you quickly turn around to face a different direction. This is undesirable.

In accordance with one or more embodiments of the invention, whether a user is inside or outside is tracked, and data for each object as to whether it is inside or outside is stored. Additionally, if an object is inside, a unique ID number representing the room where it can be found is stored. In this way, objects can be transferred down the communications link in sets, according to which room they are in. Sensible rules determine and trigger the order of rooms to send.

As someone approaches a door, e.g., the system's positioning engine (the cube), can be used to predict, with simple algorithms, that it is likely the person will walk through that door. At this point, the new room's data can begin to be transferred. In this way it is possible that some or all of the data for the new room will have been transferred to the client and cached, before the user gets to the room.

One problem that may occur is when a person is inside, and there is an opening to the outside or another room, perhaps through a doorway or window. The same issue occurs if a person is outside and there are openings through to the inside of a building. In these cases, a 2D representation of the other scene is passed as a priority. (A 2D representation can be used to provide a ‘scrolling’ horizon, as seen through the window or doorway.) Once the 2D representation has transferred, the normal 3D data can be sent using proximity, or room, or field of view methods. The 2D representation can be calculated in software from the 3D data, using a ‘snapshot’ type approach.

When a user is outside, existing methods or combinations thereof can be used.

In accordance with one or more embodiments of the invention, techniques are provided for reducing data requirements using a process of skinning objects. The cube records the position of objects on the surface within the virtual world. In accordance with one or more embodiments of the invention, a separate database holds details of those objects, such as 3D models, behavior etc. Typically, the server would pass details of each object to the client separately to allow the client to re-create a visual scene. This is standard practice in virtual worlds and MMOG's, and requires the accessing of both the positioning and object databases through separate requests.

It is an advantage to reduce the need for a system to access different databases to visually re-create a scene. It is also an advantage to reduce the initial quantity of data required to adequately re-create the initial visual appearance of a scene.

In accordance with one or more embodiments of the invention, an object can have its outer surface represented by way of a ‘skin’. The term ‘skin’ as used herein means the exterior continuous surface of an object, as if material was wrapped closely around that object. Such a skin would typically have less storage requirements than a complete 3D model. Computer software can calculate these low resolution skins from the object database periodically and can store them in the cube, where the object is positioned. Storing this kind of data in the cube will require additional storage, but not an unrealistic amount. It will reduce the need to access the object database, reduce the data that initially needs to be transferred, and will also have advantages for tracking collisions between objects, as well as advantages for quickly generating low resolution visuals for objects that are far away from a user and do not need detailed imagery. Other methods may also be used.

The detailed 3D information for objects will be stored in the object database. But here too, skins could be stored alongside the 3D object data, in different resolutions. These could be released progressively to the client, typically as the object gets closer to a user within the virtual world. So long as they are smaller in size than the core 3D object data, it will make sense to pass these to the client first. With bandwidth limitation issues, it is not usually the total size of data transferred that is an issue, but the size of ‘spurts’ of data over short periods of time, when first visually creating a scene for example.

One advantage of the skinning method is that an object can look generally exactly the same, when rendered as a skin, rather than as a complete 3D model, and a skin in many cases will be smaller in terms of data size than the corresponding 3D model.

In accordance with one or more embodiments of the invention, a melding process, which extends the skinning process described above, is provided for reducing data requirements.

It is an advantage to reduce the need for separate object requests over the telecommunications link, due to the nature of most packet-based protocols such as TCP/IP. It is also an advantage to reduce the initial quantity of data required to adequately re-create the initial visual appearance of a scene. A virtual room, e.g., would typically have many objects that are static, as in nonmoving. These static objects are typically touching other objects. An example would be a stack of books sitting on a table. Existing methods approach this problem in one of generally two ways. Either a single object is created in a 3D program that represents a table with a stack of books on it, or multiple objects for each book plus the table are created and then stacked together. Both methods have disadvantages.

A single object approach solves the problem of efficiently storing a 3D model, since there is only one object, but does not provide any capability to ‘pick up a book from the table’. The books are ‘glued’ to the table, part of the same inseparable object. A multiple objects approach solves the problem of being able to pick up a book off the table, but creates a lot of separate 3D object data to be transferred.

In accordance with one or more embodiments of the invention, a technique is provided that generally combines the best of both approaches. Extending the earlier skin process described above, a skin representing both the table and books is calculated by software and passed to the client. A skin is just one object, the outer surface of all those objects as if they had been ‘glued’ together.

In implementation, once the initial skin for table and books has been transferred, individual 3D object data gets sent. At this point, books become separable from table.

From a user's perspective, this approach makes sense. If you walk into a room, it is unlikely that you will immediately disturb any static objects within it, such as the books. It is typically more important to see the books and the table, before having the capability to pick up a book from the table.

Extending this idea further, the interior of an entire room can be represented with a single skin. This is because in real life, all objects, apart from those that are in flight, are touching another, if you consider the floor an object.

This process of creating continuous skins, for multitudes of objects that are all touching one another, is referred to herein as a ‘melding’ process. The process of transferring individual object data at a later time, to allow the objects to be detached from one another, is referred to herein as the ‘demelding’ process.

In accordance with one or more embodiments of the invention, a combination of melding and demelding, and staggering the transfer of the relevant data, is used to more efficiently pass information between server and client.

In accordance with one or more embodiments of the invention, a method for conveying surface texture and appearance is provided for reducing data requirements.

An object is comprised of both shape and appearance. Appearance might be the color of an object, its reflectivity and so on. The methods described generally relate to efficiently transferring the shape of a scene. This is because efficient storage of a skin implies very little appearance data is stored. The skin is effectively just a wireframe, or perhaps a wireframe with a single color placed upon its surface.

To convey the appearance of a scene realistically, it can be useful to transfer photo realistic surface data for every object in the scene, and wrap that around the shapes (the wireframes). Such data is intrinsically high bandwidth, because photo realistic data can only be compressed so much using data compression techniques before quality suffers. Examples of compression formats are JPEG and GIF.

Many methods have been proposed in the past for circumventing this bandwidth problem. These typically involve using tiled images, patterns, compression and other methods. These approaches have merit, and can be used in the virtual world system where appropriate.

In accordance with one or more embodiments of the invention, an alternate method is provided for transferring surface appearance data. This method extends the skin idea to surface appearance data. A second skin, representing appearance data, is computed using computer software. This photo realistic skin might represent the surface of an entire room, a single photo representing the surface of all objects in the room. It might instead simply represent certain objects within the room, those that lend themselves to a photo approach, as opposed to a tiling, or texture approach, for example.

Thus to re-create the scene, only two objects need to be passed to the client—the shape skin and the surface image skin. The surface image skin can be thought of as a photo of the scene that is wrapped around all the objects in three dimensions. It can be compressed using standard data compression formats such as JPEG and GIF.

From a viewer's perspective, the scene would unveil itself first as a wireframe, and then as photo realistic, and then as an interactive photo realistic scene where objects can be moved and manipulated. The separate 3D object data is sent after the skin data, as outlined previously.

The system in accordance with embodiments of the invention is flexible in that a combination of melded skin and individual object surface data can be passed. This can have advantages where objects can be reproduced more effectively with other methods such as tiling. In such a scenario, a decision engine can analyze a scene, and compare the various methods for conveying it, by comparing their sizes, e.g., and determining the most efficient method to transfer the scene. Accordingly, in accordance with one or more embodiments of the invention, the new methods are used in combination with existing methods to most effectively transfer data.

In accordance with one or more embodiments of the invention, an improved method for revealing a scene in the virtual world such as a photo realistic scene to the user is provided. When computing the photo realistic skin for a scene, the software can first start its calculations at a single point on the surface of an object within the scene. From here, it can ‘spread out’ in all directions ‘flowing’ over all the surfaces of objects within the scene, and calculating the photo realistic surface data as it goes, until the entire scene is computed and melded.

The advantage of such a technique would be a visual improvement when it comes to revealing or ‘playing back’ the data to the user. A user might enter a room within the virtual world, see a wireframe representation of its shape, and then soon afterwards see the photo realistic view of the scene, unveiling itself as a ‘liquid’ that flows out and across the room from a single point.

This is assuming that there is not enough time to pass all the data quickly enough to reveal a scene. This would offer a visual improvement over existing methods, which are often quite random and sudden—objects suddenly appear, or disappear, or appear jerkily.

In accordance with one or more embodiments of the invention, a storage method is provided that allows the system to read back the data starting at any point within the room, rather than a pre-selected point. In this way, the system could choose the starting point location for the ‘flow’, with a point that is closest to the viewer, or on the same side of an object that the viewer can see. This would mean that the spreading out of the photo realistic surface would be done in such a way that it flows ‘around and away’ from the user's point of view.

If the reflective and refractive properties of the material are recorded separately (as perhaps a third skin) from the photo realistic details, these qualities could also reveal themselves in a spreading out type fashion, perhaps delayed from the photo realistic skin. The visual effect of this would be an improvement over existing methods.

In accordance with one or more embodiments of the invention, an improved technique is provided for revealing demelded objects. The photo realistic skin can be unveiled first, and then individual object data is sent to the client for the objects within the scene. This allows the user to be able to move or interact with those objects.

It is preferable for the user to be able to know when this demelding process has completed. It would be frustrating to try to pick up an object that has not yet had its individual object data transferred. Accordingly, in accordance with one or more embodiments of the invention, users are notified of the completion of the demelding process. A small visual cue, consisting of a visual effect, such as blue lightning or sparks, would appear at the point on an object where it is touching another object, once the demelding process is complete. A vase, e.g., could have this visual effect around its base when the object data for the vase has finished transferring. It would last just a short time, but would be sufficient to indicate to the user that the object is demelded and can be picked up or otherwise interacted with.

In accordance with one or more embodiments of the invention, a distinction can be made between objects that are in motion or are static. This information is a useful data point to store, since it can improve the user experience. Objects that are static can be melded with the objects that they touch. Objects that are in motion are preferably not melded, and are passed as separate objects. This is so that priority can be given to moving objects if desired.

In accordance with one or more embodiments of the invention, velocity and acceleration data for objects is recorded, either individually or as typical values for objects of that type. This too could have an effect on prioritization when determining which object data to send first.

Objects within the system are preferably stored within the objects database. There are ‘library’ objects and there are ‘unique’ objects. Library objects cannot be altered, although they can have properties that can be set programmatically. This might include color, surface texture, age, dirtiness, the materials it is made out of etc. Copies of library objects can be used to derive unique objects. Unique objects can have any aspect altered.

In accordance with one or more embodiments of the invention, objects can be categorized as inflexible, mildly flexible, or flexible. In the case of inflexible objects, any three anchor points (for determining orientation) can be selected. In the case of certain ‘mildly flexible’ objects, three anchor points can be selected on parts of the object that do not move in relation to one another. In the case of ‘flexible’ objects, a system for using more than three anchor points could be used for positioning. Physical rules such as gravity and the makeup of an object in terms of materials could be used to infer position of other parts of the object.

In this way, something as complex, e.g., as a sweater could have its entire position and orientation reproduced accurately. It can be possible for instance to drape the virtual sweater over the back of a virtual chair.

Currently, virtual worlds use client-side 3D engines for generating the appearance of a 3D world. This favors access to those with more powerful computers, since powerful computer processing is needed to generate a realistic 3D world.

In accordance with one or more embodiments of the invention, a system is provided that allows users with less powerful computers to access a video streaming ‘hosted’ version of a virtual world, and thus enjoy a far more realistic version of the world, than could be generated by their own computer.

There are similarities here to ‘remote desktop’ software such as VNC and Timbuktu. Basically, a user would have a choice of accessing a standard version of the virtual world, where their own computer generates the 3D scene, or they could access a full frame video stream version of the virtual world, generated by central or peer servers. These servers would be running the same general client software, but would have the additional functionality of a streaming engine to send out the video to video stream clients. A two-way communication link would pass user commands (move left, move right, etc.) to the server, and the updated video representation of the world would be passed back to the client user using streaming video methods.

The standard client software for accessing the virtual world could have this ‘serving’ functionality built into it, meaning that other users with more powerful computers could offer video based access to users with less powerful computers, during system ‘downtime’.

In accordance with one or more embodiments of the invention, a payment system is provided, allowing users wishing to have a higher quality video based version of the service to pay for this, with proceeds, e.g., shared with peer users who opt to provide this capability to others. Such a system would have the advantage of offering anyone the capability to view the very highest quality version of the world if they wish, even if their computer is not relatively powerful.

In accordance with one or more embodiments of the invention, users can access to a range of digital filters through which to experience the virtual world. These can include, e.g., simple visual filters such as black and white, layered effects such as ‘old film look’, or more complex digital manipulation at a 3D generation level. One possible mode might be a ‘psychedelic’ mode.

By joining multiple instances of the virtual world system together, a plurality of planets can be replicated. In accordance with one or more embodiments of the invention, the space in between those planets can be geo-mapped. Such an embodiment would provide for a continual solar system that can be explored, complete with historical data for that solar system. A user could virtually travel to any location in the solar system, and at any time.

In accordance with one or more embodiments of the invention, a generally lightweight stereo 3D viewer headset in the form of portable ‘sunglasses’ is used as the display device. Along with geolocation technology and/or 3D camera technology and/or radar technology and/or ultrasound technology, combined with a small computer and wireless connection, the 3D viewer headset allows the system to provide an augmented reality, where visuals and sounds from the virtual world are layered over the real world, as seen through the headset worn by the user. In this way, a user could experience something akin to a ‘visual walkman’, with virtual characters and events juxtaposed over true reality. A user could be walking along a sidewalk, e.g., in the real world, wearing the glasses, and an animal, e.g., could run down the street as seen by the user, jumping over cars, fences and other real world objects. Object detection for this could come from the various sensors described above, or be based on information stored in the virtual world (buildings etc), or both. This is just one example, an entertainment function, but other useful functions will be possible such as route guidance, x-ray vision (see through buildings using information stored in the virtual world), and any other use where information stored in a virtual replica of the planet can be layered over your viewpoint in the real world.

With respect to the x-ray vision embodiment, if a generally complete and geographically accurate replica of the planet is stored within a system, that information can be utilized in the real world. A user with 3D glasses, e.g., walking around a town, could access information from the virtual world to layer over their vision of the real world. Geolocation and orientation data can be passed back to the virtual world to inform the virtual world of where the user is in the real world, and which way he or she is looking.

As the virtual world data becomes more accurate, and more photo realistic, a user could choose to see through a building using information generated from the virtual world. In one possible embodiment, special glasses, which would have an addressable opaque function, would allow parts of the glasses to become opaque, allowing virtual world scenery to be seen more readily instead. They could also simply be semi-transparent, allowing the user to see both real and virtual imagery.

In accordance with one or more embodiments of the invention, the reverse of the above is provided. Here, live stereo images and sounds are captured by a real person, in the real world, using a similar kind of headset as described, but with the addition of twin video cameras and microphones. The images and sounds are communicated back into the virtual world for that same location. Accordingly, a user of the virtual world could request real world images and sounds from the same location in the real world that they are located at in the virtual world. This information could also be used, e.g., to update the data in the virtual world, or augment the data in the virtual world. One example might be that building surfaces, posters on walls, or even people's faces could be captured and layered onto the same kinds of objects in the virtual world.

It is to be understood that although the invention has been described above in terms of particular embodiments, the foregoing embodiments are provided as illustrative only, and do not limit or define the scope of the invention. Various other embodiments are also within the scope of the claims. For example, elements and components described herein may be further divided into additional components or joined together to form fewer components for performing the same functions.

The techniques described above may be implemented, e.g., in hardware, software, firmware, or any combination thereof. The techniques described above may be implemented in one or more computer programs executing on a programmable computer including a processor, a storage medium readable by the processor (including, e.g., volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, e.g., be a compiled or interpreted programming language.

Method claims set forth below having steps that are numbered or designated by letters should not be considered to be necessarily limited to the particular order in which the steps are recited.

What is claimed is:

1. A method of presenting a virtual world environment to users operating client devices connected to a network, comprising:
(a) receiving data from one or more automated data miners or a plurality of contributors describing places on a planet at specified time periods;
(b) storing the data received in step (a) in one or more databases;
(c) receiving one or more requests from one of said users for data describing a place on the planet at one or more time periods; and
(d) generating multimedia representations of the place at different time periods based on data in the one or more databases, and transmitting the multimedia representations to the user to be presented to the user on a client device operated by the user, at least one of the multimedia representations including a user interface element selectable by the user to change the multimedia representation of a place at one time period to a multimedia representation of the place at a different time period.

2. The method of claim 1, wherein the user is represented by an avatar and interacts with avatars representing other users in the multimedia representations.

3. The method of claim 1 wherein the network is the Internet, and wherein the method is implemented in a server.

4. The method of claim 1 wherein the method is implemented in a peer-to-peer network.

5. The method of claim 1 wherein a plurality of requests are received from said user, including a request for the multimedia representation of the place at the different time period.

6. The method of claim 1 wherein the multimedia representations of the place at different time periods are received by and cached at the client device.

7. The method of claim 1 wherein the one or more databases store data representing positions and orientations of objects on a topography of at least portions of the planet for a plurality of time periods.

8. The method of claim 1 further comprising providing a topography of at least portions of the planet, and wherein step (a) comprises receiving data representing positions and orientations of objects on the topography for a plurality of time periods.

9. The method of claim 1 further comprising receiving historical data associated with said places at specified time periods from said contributors or one or more automated data miners and storing said historical data in said one or more databases.

10. The method of claim 9 further comprising storing a reliability of information indicator with said historical data.

11. The method of claim 1 further comprising interpolating missing data in said one or more databases.

12. The method of claim 1 further comprising prioritizing transfer of objects in the multimedia representations transmitted to the user in accordance with a location of an avatar representing the user relative to a room.

13. The method of claim 1 further comprising representing objects as skins, and selectively using skins in place of more detailed object data in multimedia representations transmitted to the user.

14. The method of claim 1 further comprising melding objects in multimedia representations transmitted to the user.

15. The method of claim 1 further comprising representing appearance data for objects as skins in multimedia representations transmitted to the user.

16. The method of claim 1 wherein each multimedia representation reveals itself to the user from a point that spreads out from the point over objects until the representation is shown to the user.

17. The method of claim 1 wherein the client device includes a 3D engine for processing the multimedia representations.

18. The method of claim 1 wherein transmitting the multimedia representations to the user comprises streaming video to the user.

19. The method of claim 1 further comprising determining the location of the user in the real world, and transmitting multimedia representations of said location to the user such that the user can generally simultaneously experience real and virtual worlds for said location.

20. The method of claim 19 wherein the client device comprises a virtual reality headset that allows the user to generally simultaneously view the real and virtual worlds.

21. The method of claim 19 wherein said multimedia representations of said location include images of said location transposed on the user's view of the real world.

22. The method of claim 1 further comprising determining the location of the user in the real world, and receiving from the user data on said location to update the multimedia representation of said location.

23. The method of claim 1 wherein the multimedia representations of a location can be played back to a different time period.

24. A system for presenting a virtual world environment to users operating client devices connected to a network, comprising:
a computer system for receiving data from one or more automated data miners or a plurality of contributors describing places on a planet at specified time periods; and
one or more databases for storing said data;
wherein the computer system receives one or more requests from one of said users for data describing a place on the planet at one or more time periods, generates multimedia representations of the place at different time periods based on data in the one or more databases, and transmits the multimedia representations to the user to be presented to the user on a client device operated by the user, at least one of the multimedia representations including a user interface element selectable by the user to change the multimedia representation of a place at one time period to a multimedia representation of the place at a different time period.

25. The system of claim 24, wherein the user is represented by an avatar and interacts with avatars representing other users in the multimedia representations.

26. The system of claim 24 wherein the network is the Internet, and wherein the computer system comprises a server.

27. The system of claim 24 wherein the computer system comprises one or more computers in a peer-to-peer network.

28. The system of claim 24 wherein a plurality of requests are received from said user, including a request for the multimedia representation of the place at the different time period.

29. The system of claim 24 wherein the multimedia representations of the place at different time periods are received by and cached at the client device.

30. The system of claim 24 wherein the one or more databases store data representing positions and orientations of objects on a topography of at least portions of the planet for a plurality of time periods.

31. The system of claim 24 wherein the computer system provides a topography of at least portions of the planet, and receives data representing positions and orientations of objects on the topography for a plurality of time periods.

32. The system of claim 24 wherein the computer system receives historical data associated with said places at specified time periods from said contributors or one or more automated data miners and stores said historical data in said one or more databases.

33. The system of claim 32 wherein a reliability of information indicator is stored in said one or more databases with said historical data.

34. The system of claim 24 wherein the computer system interpolates missing data in said one or more databases.

35. The system of claim 24 wherein the computer system prioritizes transfer of objects in the multimedia representations transmitted to the user in accordance with a location of an avatar representing the user relative to a room.

36. The system of claim 24 wherein the computer system represents objects as skins, and selectively uses skins in place of more detailed object data in multimedia representations transmitted to the user.

37. The system of claim 24 wherein the computer system melds objects in multimedia representations transmitted to the user.

38. The system of claim 24 wherein the computer system represents appearance data for objects as skins in multimedia representations transmitted to the user.

39. The system of claim 24 wherein each multimedia representation reveals itself to the user from a point that spreads out from the point over objects until the representation is shown to the user.

40. The system of claim 24 wherein the client device includes a 3D engine for processing the multimedia representations.

41. The system of claim 24 wherein the computer system transmits the multimedia representations to the user by streaming video to the user.

42. The system of claim 24 wherein the computer system determines the location of the user in the real world, and transmits multimedia representations of said location to the user such that the user can generally simultaneously experience real and virtual worlds for said location.

43. The system of claim 42 wherein the client device comprises a virtual reality headset that allows the user to generally simultaneously view the real and virtual worlds.

44. The system of claim 42 wherein said multimedia representations of said location include images of said location transposed on the user's view of the real world.

45. The system of claim 24 wherein the computer system determines the location of the user in the real world, and receiving from the user data on said location to update the multimedia representation of said location.

46. The system of claim 24 wherein the multimedia representations of a location can be played back to a different time period.

47. A method of experiencing a virtual world environment by a user operating a client device connected to a computer system, said computer system storing data received from one or more automated data miners or a plurality of contributors describing places on a planet at specified time periods, the method comprising:
transmitting one or more requests to the computer system for data describing a place on the planet at one or more time periods; and
receiving multimedia representations of the place at different time periods generated by said computer system based on data in the one or more databases, said multimedia representations being presented to the user on the client device operated by the user, at least one of the multimedia representations including a user interface element selectable by the user to change the multimedia representation of a place at one time period to a multimedia representation of the place at a different time period.

48. The method of claim 47, wherein the user is represented by an avatar and interacts with avatars representing other users in the multimedia representations.

49. The method of claim 47 wherein the network is the Internet, and wherein the computer system is a server.

50. The method of claim 47 wherein the computer system comprises one or more computers in a peer-to-peer network.

51. The method of claim 47 wherein a plurality of requests are transmitted by said user, including a request for the multimedia representation of the place at the different time period.

52. The method of claim 47 wherein the multimedia representations of the place at different time periods are received by and cached at the client device.

53. The method of claim 47 wherein the transfer of objects in the multimedia representations transmitted to the user is prioritized in accordance with a location of an avatar representing the user relative to a room.

54. The method of claim 47 wherein one or more objects are represented as skins and used in place of more detailed object data in multimedia representations received by the user.

55. The method of claim 47 further objects are melded in multimedia representations received by the user.

56. The method of claim 47 wherein appearance data for objects is represented as skins in multimedia representations received by the user.

57. The method of claim 47 wherein each multimedia representation reveals itself to the user from a point that spreads out from the point over objects until the representation is shown to the user.

58. The method of claim 47 wherein the client device includes a 3D engine for processing the multimedia representations.

59. The method of claim 47 wherein the multimedia representations received by the user comprise video streamed to the user.

60. The method of claim 47 further comprising transmitting to the computer system information on the location of the user in the real world, and receiving multimedia representations of said location such that the user can generally simultaneously experience real and virtual worlds for said location.

61. The method of claim 60 wherein the client device comprises a virtual reality headset that allows the user to generally simultaneously view the real and virtual worlds.

62. The method of claim 61 wherein said multimedia representations of said location include images of said location transposed on the user's view of the real world.

63. The method of claim 47 further comprising transmitting to the computer system information on the location of the user in the real world, and transmitting to the computer system data on said location to update the multimedia representation of said location.

64. The method of claim 47 wherein the multimedia representations of a location can be played back to a different time period.
